(19) United States
(12) Patent Application Publication
(10) Pub. No.: US 2015/0061547 A1
(43) Pub. Date: Mar. 5, 2015

(54) Locking and Synchronizing Controller for Hall-sensor Driven Motors

(71) Applicants: Milad Gougani, West Vancouver (CA); Juri Jatskevich, Vancouver (CA); Mehrdad Chapariha, Vancouver (CA)

(72) Inventors: Milad Gougani, West Vancouver (CA); Juri Jatskevich, Vancouver (CA); Mehrdad Chapariha, Vancouver (CA)

(21) Appl. No.: 14/019,496

(22) Filed: Sep. 5, 2013

(51) Int. Cl. H02P 5/52; H02P 6/00

(52) U.S. Cl. CPC H02P 5/526; H02P 6/001
USPC 318/85

(57) ABSTRACT

Disclosed embodiments include a method for locking and synchronizing Hall-sensor driven motors electronically. A programmable integrated circuit microcontroller is positioned between the Hall-sensors and the motor drivers. The microcontroller is programmed to receive signals from the Hall sensor, mitigate the errors introduced due to uneven magnetization and sensor misalignments, and then synchronize/lock the angle and speed of the motors such that the motors operate as if on a common shaft.

### FIELD

The present invention relates to a Hall-sensor based controller for locking and synchronizing independently driven motors.

### BACKGROUND

In practice Hall-sensor driven motors are locked/synchronized using conventional control techniques. But independently driven motors are never truly locked/synchronized unless they are driven by the same magnetic field or physically connected to each other through shafts and/or gears. There are various techniques to address this problem electronically (such as running motors in a master-slave topology), but none of the proposed solutions truly lock/synchronize motors at an average speed with no one motor dictating speed of the locked/synchronized motors as a whole.

In this invention, we are using Hall-sensor signals of the motors to run them with a single average signal thereby locking their magnetic fields and running them at an average speed. The developed controller is fundamentally different from conventional methods; such as speed or position PI controllers, etc., in that both speed and position of the motors become locked/synchronized internally through corresponding magnetic fields of the participating machines. The proposed locking/synchronizing technique is novel, as the Hall signals have not been considered in the past for locking/synchronizing multiple motors.

Since Hall sensors are not positioned accurately in practice, the mentioned technique is further enhanced by processing/filtering the Hall-sensor signals. So to address this problem, we have also invented a filtering technique to correct poorly aligned sensors before using the signals for control/synchronization purposes. The filtering technique can also be used in other industrial applications for improving single and multiple Hall-sensor controlled motors.

### SUMMARY

In accordance with the present invention the developed Sync-Lock Controller (SLC) is based on filtering and averaging the Hall sensor signals and applying the same switching intervals to the participating motors. A control-level averaging approach is developed to lock/synchronize the operation of the driving motors and equalize their speed and position. In this approach a multi-stage digital filtering block is also added to remove the errors in the original Hall-sensor signals. Each stage of the filter is designed to cancel the undesirable harmonics due to one of the error sources, the unevenly magnetized reaction tablet and the misaligned Hall sensors. Furthermore an analog and a digital implementation of the proposed controller are developed and described in detail.

The digital implementation of the controller is realized using a microcontroller. The controller in the form of a standalone dongle-circuit is placed between the original Hall-sensors and the motor drive to process the signals and filter out all undesirable errors in the signals. A compact prototype of the proposed dongle is fabricated and texted on a number of typical industrial Direct Current (DC) motors and drivers. Due to its simplicity and effective implementation, the developed algorithm can be readily applied to a variety of systems that use DC motors and drivers. The performance of the locking algorithm has been demonstrated using DC motors (with Hall-sensor positioning errors) and is shown to be efficient and robust in steady state and transients studies. The performance of the SLC was evaluated under different conditions. It was shown that the SLC improves the performance of the system under certain conditions compared to the conventional PI speed control loops.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is schematic of a DC motor-drive system with the proposed Sync-Lock Controller.

FIG. 2 is a diagram of a proposed averaging of the Hall sensor signals for the SLC.

FIG. 3 is a diagram of an analog implementation of the SLC that enables the timing of the input and output Hall signal transitions.

FIG. 4 is a graph representing the timing of the input and output Hall signal transitions using the analog implementation of the proposed SLC.

FIG. 5 is a schematic showing the timing of the input and output Hall signal transitions using the proposed digital implementation of the SLC.

FIG. 6 is a diagram illustrating the proposed two-DC motor-drive vehicular propulsion system.

FIG. 7 is a representation of stator currents with unequal conduction intervals due to Hall-sensor misalignment.

FIG. 8 is a schematic of the timing of the input and output Hall signal.

FIG. 9 is a schematic of the timing of the input and output Hall signal transitions (averaging).

FIG. 10 is a schematic of the timing of rising edge input and output interrupts.

FIG. 11 is a schematic of the timing of falling edge input and output interrupts.

FIG. 12 is a flow chart of the developed algorithms.

FIG. 13 is a flow chart of the software output Interrupt Service Routines (ISR).

FIG. 14 is a simplified diagram of the SLC unit, showing the input and output Hall signals.

FIG. 15 is the SLC hardware for use with existing motor drivers: (a) actual-size photo of the printed circuit board; and (b) simplified block-scheme representation depicting major components and ports.

### DETAILED DESCRIPTION

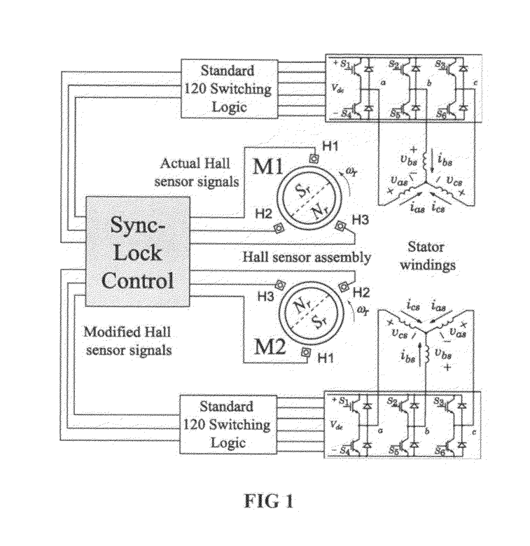

A Hall-sensor based controller for locking and synchronizing independently driven DC motors, will now be described with reference to FIG. 1 through 15.

This following prior art publications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply
[1] E. H. Wakefield, History of the Electric Automobile: Battery-only Powered Cars, Society of Automotive Engineers (SAE), ISBN: 1-56091-299-5, Warrendale, Pa., 1994.
[2] M. Ehsani, Y. Gao, S. E. Gay, and A. Emadi. Modern Electric Hybrid Electric, and Fuel Cell Vehicles: Fundamentals, Theory, and Design. CRC Press, Boca Raton, Fla., 2005.
[3] P. C. Krause, O. Wasynczuk, S. D. Sudhoff, Analysis of Electric Machinery and Drive Systems. IEEE Press, Piscataway, N.J., 2002.
[4] J. P. Johnson, M. Ehsani, Y. Guzelgunler, “Review of Sensorless Methods for Brushless DC,” In Proc. Industry Applications Conference, 1999. Thirty-Fourth IAS Annual Meeting. Conference Record of the 1999 IEEE, Vol. 1, pp. 143-150, Oct. 3-7, 1999.
[5] T. Senjyu, K. Uezato, “Adjustable Speed Control of Brushless DC Motors without Position and Speed Sensors,” In Proc. Int'l. IEEE/IAS Conf. on Industrial Automation and Control: Emerging Technologies, pp. 160-164, 1995.
[6] A. Consoli, S. Musumeci, A. Raciti, A. Testa, “Sensorless Vector and Speed Control of Brushless Motor Drives,” IEEE Trans. on Industrial Electronics, Vol. 41, pp. 91-96, February, 1994.
[7] P. Acarnley, “Sensorless Position Detection in Permanent Magnet Drives”, IEE Colloquium on Permanent Magnet Machines and Drives, pp. 1011-1014, 1993.
[8] K. Iizuka, et al., “Microcomputer Control for Sensorless Brushless Motor,” IEEE Transactions on Industry Applications, Vol. IA-27, pp. 595-601, May-June, 1985.
[9] W. Brown, “Brushless DC Motor Control Made Easy”, Microchip Technology Inc., 2002. [Online] Available: www.microchip.com
[10] K. R. Shouse, D. G. Taylor, “Sensorless Velocity Control of Permanent-Magnet Synchronous Motors”, In Proc. 33rd Conf. on Decision and Control, pp. 1844-1849, December, 1994.
[11] N. Ertugrul, P. Acarnley, “A New Algorithm for Sensorless Operation of Permanent Magnet Motors,” IEEE Transactions on Industry Applications, Vol. 30, pp. 126-133, January-February, 1994.
[12] N. Matsui, “Sensorless PM Brushless DC Motor Drives,” IEEE Transactions on Industrial Electronics, Vol. 43, pp. 300-308, April, 1996.
[13] M Schrodl, “Sensorless Control of Permanent Magnet Synchronous Motors,” Electric Machines and Power Systems, Vol. 22, pp. 173-185, 1994.
[14] B. J. Brunsbach, G. Henneberger, T. Klepseh, “Position Controlled Permanent Magnet Excited Synchronous Motor without Mechanical Sensors,” In Proc. IEE Conf on Power Electronics and Applications, Vol. 6, pp. 38-43, 1993.
[15] M. Benarous, J. F. Eastham, P. C. Coles, “Sinusoidal Shaft Position Encoder,” In Proc. Power Electronics, Machines and Drives (PEMD 2004), Vol. 1, Mar. 31-Apr. 2, 2004 pp. 132-136
[16] Y. Buchnik, R. Rabinovici, “Speed and Position Estimation of Brushless DC Motor in Very Low Speeds,” In Proc. Convention of Electrical and Electronics Engineers in Israel, Sep. 6-7, 2004 pp. 317-320
[17] M. Gougani, M. Chapariha, J. Jatskevich, “Locking electric differential for brushless DC machine-based electric vehicle with independent wheel drives,” Vehicle Power and Propulsion Conference (VPPC), 2011 IEEE, pp. 1-6, 6-9 Sep. 2011.
[18] M. Gougani, M. Chapariha, J. Jatskevich, A. Davoudi, “Hall Sensor-Based Locking Electric Differential System for BLDC Motor Driven Electric Vehicles,” International Electric Vehicle Conference (IEVC), 2012 IEEE, pp. 1-7, 4-8 Mar. 2012.
[19] N. Samoylenko, Q. Han, J. Jatskevich, “Balancing hall-effect signals in low-precision brushless DC motors,” In Proc. IEEE Applied Power Electronics Conference, Feb. 28-Mar. 2, 2007, Anaheim Calif., USA, pp. 606-611.
[20] N. Samoylenko, Q. Han, J. Jatskevich, “Improving dynamic performance of low-precision brushless DC motors with unbalanced Hall sensors,” In Proc. IEEE Power Engineering Society General Meeting, Panel Session Intelligent Motor Control I, June 24-28, 2007, Tampa Fla., USA.
[21] P. Alaeinovin, “Analysis and improvement of low precision Hall-sensor-controlled brushless dc motors,” M. S. thesis, Dept. Elect. Eng., Univ. British Columbia, Vancouver, 2010.
[22] Simulink: Dynamic System Simulation for MATLAB, Using Simulink Version 7.3, The MathWorks Inc., 2009a.
[23] Automated State Model Generator (ASMG), Reference Manual Version 2, P. C. Krause & Associates, Inc. 2003.
[24] N. Samoylenko, H. Qiang, J. Jatskevich, “Dynamic Performance of Brushless DC Motors with Unbalanced Hall Sensors,” Energy Conversion, IEEE Transactions on, vol. 23, no. 3, pp. 752-763, September 2008.
[25] P. Pillay, R. Krishnan, “Modeling, simulation, and analysis of permanent-magnet motor drives. Part II. The brushless DC motor drive,” IEEE Transactions on Industry Applications, Vol. 25, Iss. 2, March-April 1989, pp. 274-279.
[26] S. D. Sudhoff, P. C. Krause, “Average-value Model of the Brushless DC 120° Inverter System,” IEEE Transactions on Energy Conversion, Vol. 5, No. 3, pp. 553-557, 1990.
[27] S. D. Sudhoff, P. C. Krause, “Operation Modes of the Brushless DC Motor with a 120° Inverter,” IEEE Transactions on Energy Conversion, Vol. 5, No. 3, pp. 558-564, 1990.
[28] P. L. Chapman, S. D. Sudhoff, C. A. Whitcomb, “Multiple Reference Frame Analysis of Non-sinusoidal Brushless DC Drives,” IEEE Transactions on Energy Conversion, Vol. 14, No. 3, pp. 440-446, 1999.
[29] W-S. Kim, Y-S. Kim, J-K. Kang, and S-K. Sul, “Electro-mechanical re-adhesion control simulator for inverter-driven railway electric vehicle”, Conference Record of the 1999 IEEE Industry Applications Conference, 2:1026-1032, 1999.
[30] Y. Takaoka, A. Kawamura, “Disturbance Observer Based Adhesion Control for Sinkansen”, AMC2000-NAGOYA, 2000, pp. 169-174.
[31] F. Rodriguez, A. Emadi, “A Novel Digital Control Technique for Brushless DC Motor Drives” IEEE Trans. Industrial Electronics Vol. 54, Iss. 5, pp. 2365-2373, October 2007.
[32] Pan Ching-Tsai, E. Fang, “A Phase-Locked-Loop-Assisted Internal Model Adjustable-Speed Controller for BLDC Motors” IEEE Trans. Industrial Electronics Vol. 55, Iss. 9, pp. 3415-3425, September 2008.
[33] S. Rajagopalan, J. M. Aller, J. A. Restrepo, T. G. Habetler, R. G. Harley, “Analytic-Wavelet-Ridge-Based Detection of Dynamic Eccentricity in Brushless Direct Current (BLDC) Motors Functioning Under Dynamic Operating Conditions” IEEE Trans. Industrial Electronics Vol. 54, Iss. 3, pp. 1410-1419, June 2007.
[34] Chung-Wen Hung, Cheng-Tsung Lin, Chih-Wen Liu, “Fuzzy PI Controller for BLDC motors Considering Variable Sampling Effect” In Proc. 33rd Annual Conf. of the IEEE Industrial Electronics Society (IECON), Nov. 5-8, 2007, Taipei, Taiwan, pp. 1175-1179.
[35] A. Sathyan, N. Milivojevic, Y. J. Lee, M. Krishnamurthy, A. Emadi, “An FPGA Based Novel Digital PWM Control Scheme for BLDC Motor Drives,” Accepted to IEEE Trans. Industrial Electronics, (Paper TIE.2009.2022067).
[36] Dan Liu, Changliang Xia, Maohua Zhang, Yingfa Wang, “Control of Brushless DC Motor Using Fuzzy Set Based Immune Feedback PID Controller,” In Proc. IEEE International Symposium on Industrial Electronics (ISIE 2007), 4-7 Jun. 2007, pp. 1045-1049.
[37] P. B. Beccue, S. D. Pekarek, B. J. Deken, A. C. Koenig, “Compensation for asymmetries and misalignment in a Hall-effect position observer used in PMSM torque-ripple control,” IEEE Trans. Industry Applications, Vol. 43, No. 2, pp. 560-570, 2007.
[38] B. Tabbache, A. Kheloui, N. Hanini, “An electric differential system for a two-wheel mobile plat-form using direct torque control with adaptive flux and speed observers,” Power Electronics, Electrical Drives, Automation and Motion, 2008. SPEEDAM 2008. International Symposium on, vol., no., pp. 550-556, 11-13 Jun. 2008
[39] J. G. Proakis, D. G. Manolakis, Digital Signal Processing, Prentice Hall, Upper Saddle River, N.J., 1996, p. 248.
[40] dsPIC30f1010/202x Data Sheet, 28/40/44-Pin High-Performance Switch Mode Power Supply Digital Signal Controllers. Microchip Technology Inc., 2006 [Online]. Available: www.microchip.com
[41] Reston Condit “Sensorless BLDC with Back-EMF Filtering,” Microchip Technology Inc. Available: http://ww1.microchip.com/downloads/en/AppNotes/01083a.pdf
[42] J. Larminie and J. Lowry. Electric Vehicle Technology Explained. John Wiley & Sons, West Sussex, England, 2003.
[43] D. Juan, M. Ortuzar, Tests results with regenerative braking based on super-capacitors and a buck-boost converter. Berlin, 2001

### Structure and Relationship of Parts:

A Hall-sensor based controller for locking and synchronizing independently driven DC motors is provided in this invention. The developed controller electronically locks both position and speed of the active motors as if they were operating on a common “virtual” shaft.

The Sync-Lock controller (SLC), locks/synchronizes the DC motors via the corresponding Hall sensor signals. The developed technique drives both the motors with a set of “averaged” signals thereby locking speed and angle of both motors. This locking strategy is different from a soft lock approach based on a PI controller as the two motors are locked internally by coupling the respective magnetic fields by using Hall sensor signals. Therefore both the speed and position of the motors are synchronized/locked.

The SLC is implemented digitally using a programmable integrated circuit microcontroller. First, the Hall signals undergo a layer of filtering to mitigate the errors due to hall sensor misalignment. Then, the locking algorithm is implemented by averaging the filtered Hall sensor signals. Without loss of generality, two DC motors are assumed here, whereas the SLC concept (locking/synchronizing algorithm) is readily extended for any number of motors. The controller is realized in the form of a standalone dongle-circuit that can be easily placed between the original Hall-sensors and the DC motor driver. Operation of typical industrial DC motors with the developed controller is shown to outperform conventional controllers and lock both speed and angle of the motors.

The proposed controller block diagram is shown in FIG. 1. The Hall signals in this configuration are fed through the controller and the motors are run with a single set of Hall signals when the controller is activated. Otherwise, motors will operate with their respective signals.

Given the system configuration of FIG. 1, a supervisory controller (i.e. proposed SLC) is needed to lock/synchronize the motors as there is no direct mechanical connection between them [2]. This synchronization and locking of motors, means that the controller is required to control both speed and relative positions of the motors. Primary objective of such controller is to emulate operation of a simple mechanical shaft whereby positions of the motors are locked together and forced to operate at a constant relative position. This locking of motors is also desirable under certain conditions to improve stability of the system [17]. It should be noted that with this configuration the controller also facilitates different speeds for the motors, as it is needed for certain operations.

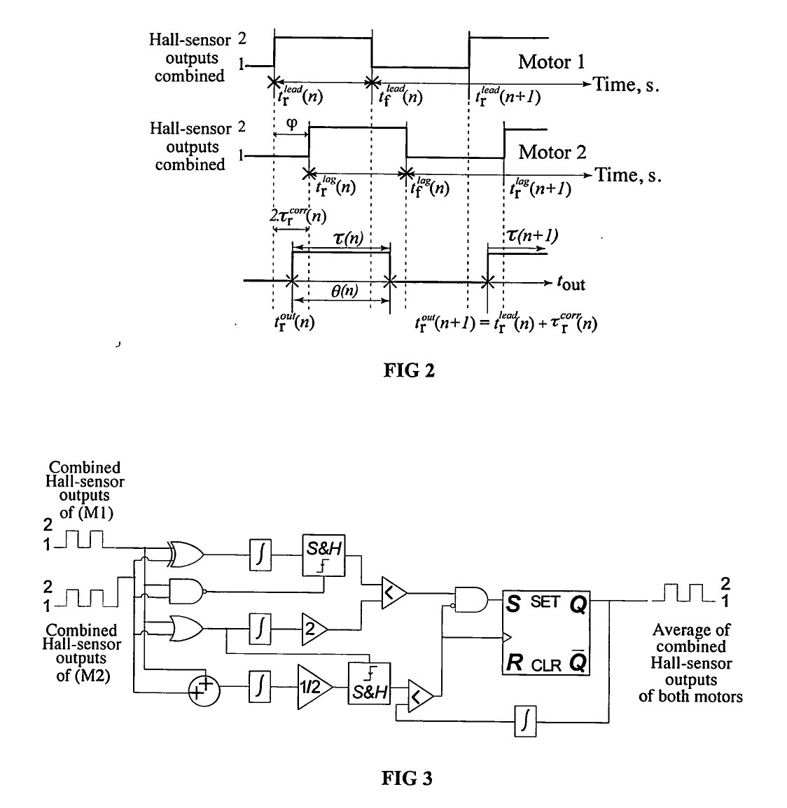

To better understand how to lock/synchronize Hall-sensor signals, it is instructive to consider the diagram depicted in FIG. 2. When the motor is running, Hall sensors produce square wave signals displaced by exactly 120 electrical degrees relative to each other. Each turn is 360 mechanical degrees and 360×P electrical degrees where P is the number of pole-pairs. Output state of each Hall sensor as a function of rotor position is defined in Table 1. Combining all three outputs produces a square wave (see FIG. 2, top first and second signals) with a period equal to one-third (60 electrical degrees) of a Hall-sensor period (180 electrical degrees).

The angular intervals between two successive switching events are denoted by θ(n). Durations of intervals θ(n) are denoted here by τ(n). Here, the angle φ denotes a possible delay or advance between rotors of the two motors [3]. These signals are used by inverter to provide the stator with desired voltages. Switching logic of the transistors in inverter is summarized in Table 2. Transistor numbers in this Table correspond to what is shown in FIG. 1.

TABLE 1
Hall sensor states as a function of rotor position

| | |
|---|---|
| H₁ on | −90 − φ ≦ θᵣ ≦ 90 − φ |
| H₂ on | 30 − φ ≦ θᵣ ≦ 210 − φ |
| H₃ on | 150 − φ ≦ θᵣ ≦ 330 − φ |

TABLE 2
Standard switching intervals of a 120-degree inverter

| Switching | | Transistors |
|---|---|---|
| interval | Rotor position | on |
| 1 | −30 − φ ≦ θᵣ ≦ 30 − φ | 5.1 |
| 2 | 30 − φ ≦ θᵣ ≦ 90 − φ | 1.6 |
| 3 | 90 − φ ≦ θᵣ ≦ 150 − φ | 6.2 |
| 4 | 150 − φ ≦ θᵣ ≦ 210 − φ | 2.4 |
| 5 | 210 − φ ≦ θᵣ ≦ 270 − φ | 4.3 |
| 6 | 270 − φ ≦ θᵣ ≦ 330 − φ | 3.5 |

The SLC is based on constructing one set of Hall signals by appropriately modifying (averaging) signals from the actual sensors H_{M1}{1,2,3} and H_{M2}{1,2,3}, respectively. The controller method works by first finding the rising edge correction interval τᵣ^{corr}(n) by means of averaging switching times t(n) as follows:

τᵣ^{corr}(n)=½(tᵣ^{log}(n)−tᵣ^{lead}(n)). (1)

Once the correction value τᵣ^{corr}(n) is established, actual timing for commutating the inverter transistors for next cycle can be found as follows:

tᵣ^{out}(n+1)=tᵣ^{lead}(n+1)+τᵣ^{corr}(n), (2)

where tᵣ^{lead}(n) the leading motors switching time, is defined as reference switching time of the system. Based on (1) and (2), period of the average signal can be calculated as

τ(n+1)=½((t_{f}^{lead}(n)−tᵣ^{lead}(n))+(t_{f}^{lag}(n)−tᵣ^{lag}(n))). 3)

In general, the SLC can be implemented using either an analog method (which is based on combination of logic gates, integrators, and a flip flop) or a digital method (which is based on a programmable integrated circuit microcontroller and digital signal processing). These approaches are briefly described below:

### Analog Method

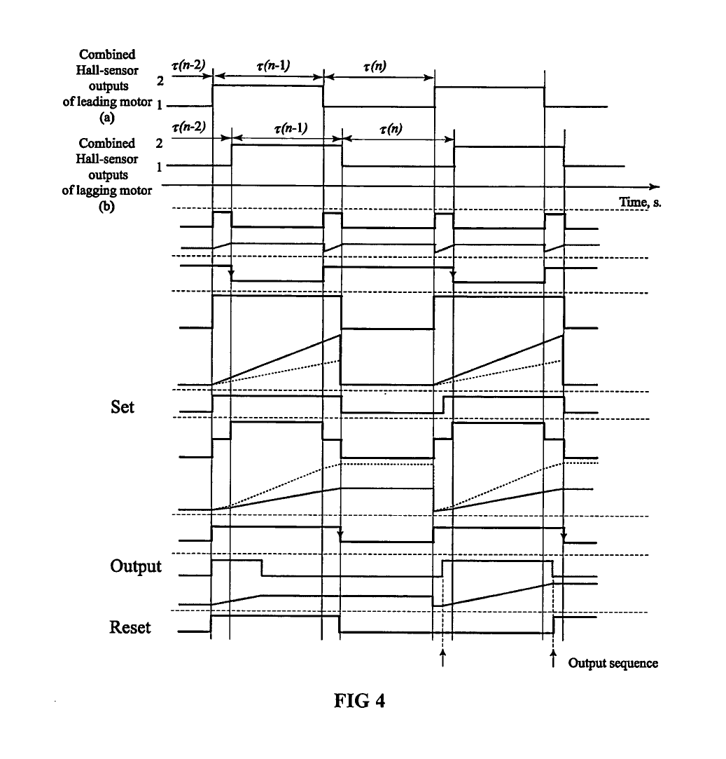

Analog implementation of the SLC is based on logic gates for processing signals, integrals for time measurements, sample and hold block for memory, and a flip flop as shown in FIG. 3. Details of the timing signals in analog approach are shown in FIG. 4. According to this implementation, the averaging is based on four basic operations: 1) time difference between the two signals is calculated by integrating XOR of the two signals and sampling the integrated signal (i.e. time difference) at falling edge of [H1 (NAND) H2]; 2) an OR gate along with an integrator is used to set up a time reference which is compared to half of time difference in step (1) to set the flip flop; 3) average period of the two signals is calculated by integrating algebraic sum of the two signals and sampling half of the result at falling edge of [H1 (OR) H2]; and 4), finally, period of the output signal is compared to average period of step (3) to trigger the reset of flip flop.

The analog implementation of SLC averages combined signals and creates a new set of averaged signals that is used to control the inverters. Average signal essentially delays leading motor and advances lagging motor, and therefore locking the two motors. It should be mentioned that this implementation operates regardless of relative positions of the two motors and there is no need to distinguish (differentiate) leading and lagging motor.

### Digital Method

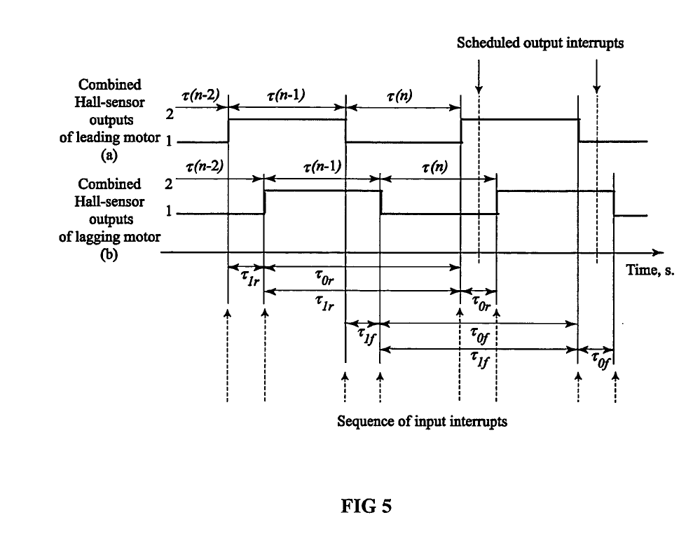

Here we present an implementation of the SLC that can easily be used with existing drive systems. The averaging algorithm is implemented using an interrupt-based approach that is suitable for digital signal processors (DSPs) or programmable microcontroller integrated circuits (PICs). The interrupt service routines (ISR) are triggered at switching points of the Hall signals. Here, each rising and falling edge ISR is considered to have a dedicated timer which is used to save last two time periods between the edges as shown in FIG. 5. These time intervals are readily available simply as timer counts between Hall-sensor transitions. To run the motors with a single set Hall signals and switch transistors at the same time, output ISR needs to be invoked at a particular time to provide the inverters with modified Hall signals. With the latest time interval between interrupts denoted by τ₀, and the following one defined as τ₁ output interrupt is scheduled when τ₀>τ₁ which is to be triggered after τ₁/2 seconds. Same logic is used for averaging both rising and falling edges of the signals. It should be noted that in the mentioned averaging technique there is no need to differentiate between leading and lagging motor, which makes this approach different from a master-slave configuration.

### Digital Method in Detail+Correction Filter

In a typical design configuration of DC machines, Hall sensors are mounted on a printed circuit board (PCB) attached to rear end of the motor. For a two pole machine, Hall sensors must ideally be placed exactly 120 degrees apart to produce control signals necessary for the standard 120-degree switching logic to control the six-step voltage-source inverter [27], [25], and [9]. If this is true, then Hall sensor signals will have consecutive transitions spaced out by exactly 60 electrical degrees. Although this is a common assumption in most literature sources, this condition is difficult to achieve in practice particularly in many mass-produced motors due to manufacturing tolerances. Therefore, to utilize Hall sensor signals for control purpose, these signals have to be filtered first to mitigate the errors [24], [19]-[21].

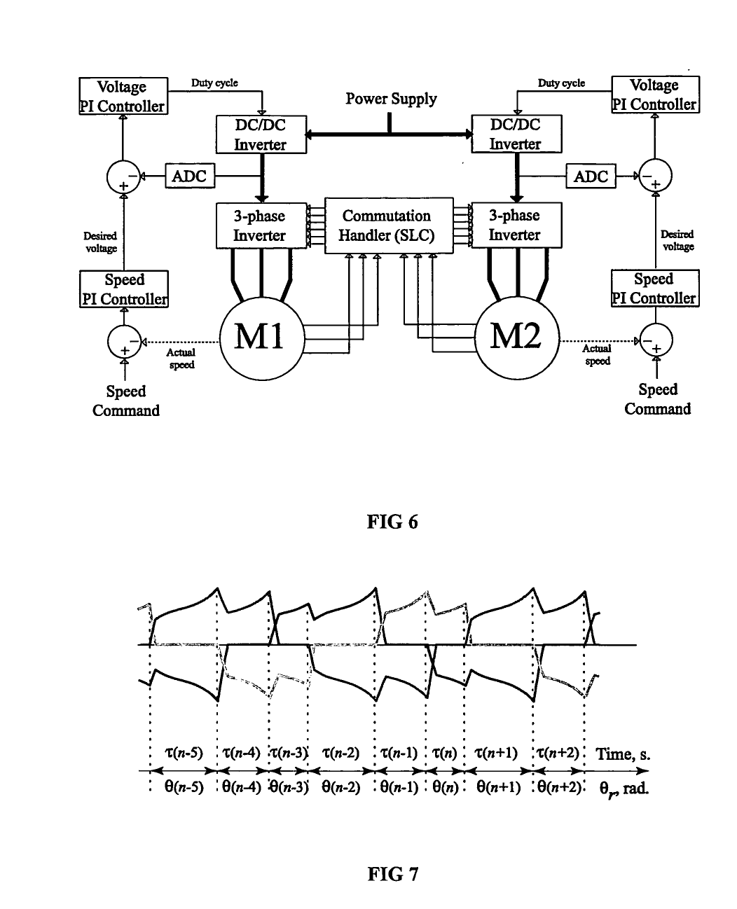

In this invention, the digital implementation of the SLC takes into account Hall sensor misalignments. The implementation is based on typical three-phase DC motors [17] as shown in FIG. 6, where we consider two motors to demonstrate the proposed concept. Aforementioned filtering and locking algorithm is then applied directly to the original Hall sensor signals to produce a modified set of signals that are used to the drive both inverters as depicted in FIG. 6.

Implementation of SLC with Correction for Hall Sensor Misalignment

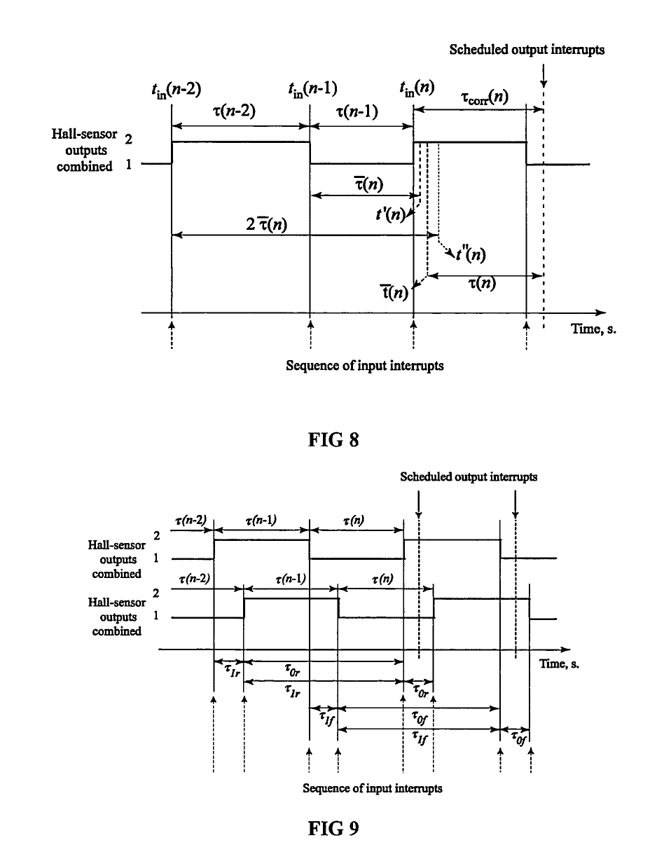

The poorly aligned Hall sensors are quite common in mass-produced DC motors as has been described in literature [19]-[21], [24]. Since such motors are very likely to be found in industrial applications, this phenomenon has to be considered for the purpose of this invention. FIG. 7 depicts phase currents of sample prototype motors. Here, the angular- and time-duration between each subsequent Hall sensor transition is denoted by θ(n) and τ(n), respectively, and n denotes the interval number. In case of a DC motor with ideally-placed Hall sensors, angular duration θ(n) between subsequent Hall sensor transitions should be 60 degrees for all n, which is clearly not true in FIG. 8. Also, in steady state operation, time intervals τ(n) should be equal. Such unbalanced conduction among the phases is not suitable for control purposes and it also leads to increase in the torque ripple as has been shown in [24], and is therefore very undesirable.

The developed Sync-Lock Control strategy synchronizes DC motors via corresponding Hall sensor signals as depicted in FIG. 6. However, to apply this locking technique effectively, the errors due to Hall sensor misalignment must be removed first. Said filter is considered here to mitigate inaccurate positioning of the Hall sensors.

### Digital Implementation of Hall-Sensor Signals Filtering

The mentioned filtering algorithm can be readily implemented on a microcontroller using the so-called software interrupt service routines (ISR). Using this method, switching of Hall sensors triggers the input ISR, at which time all necessary calculations (instructions) are done inside the microcontroller. With dedicated timers for the rising and falling edges, continuous operation of drive is enabled by resetting internal time counter of the microcontroller back to zero at either rising or falling edges of input signals. Hence, time intervals τ(n) are readily available simply as the timer counts between rising and falling edges of Hall-sensor signals. To switch transistors when the filter is enabled, software output ISR has to be invoked at a particular time to provide the inverter with modified Hall signals. This time of the next switching may be expressed as

tₙₑₓₜ_{_{—}}_{sw}= t̅(n)+ τ̅(n)=tₒᵤₜ(n+1) (4-7)

where τ̅(n) denotes averaged time interval as calculated using any of the filters (4-3)(4-6), and t̅(n) is the so-called reference switching time. Also, here tₒᵤₜ(n+1) refers to the time when the modified output Hall signals will be switched.

In order to minimize computational resources, a direct implementation of (4-7) cannot be considered as it requires continuous calculation of both the reference time t̅(n) and the averaged interval τ̅(n). For an efficient implementation of (4-7), we need to relate the time tₒᵤₜ(n+1) (when the modified output Hall signals will be switched) to the time when original Hall signal has triggered the input ISR. Denoting most-recent calling of the input ISR by tᵢₙ(n), time of the next output ISR can be expressed as:

tₒᵤₜ(n+1)=tᵢₙ(n)+τ^{corr}(n) (4-8)

where τ^{corr}(n) is the appropriate correction term. Equation (4-8) is very straightforward and computationally efficient as it requires a simple scheduling of the output ISR by offset correction time τ^{corr}(n) without the need for reference time as in (4-7). In this implementation, the output ISR is scheduled by simply comparing value of the timer and correction term.

Calculation of correction time τ^{corr}(n) is best understood by considering FIG. 8. The bottom axis in FIG. 9 depicts the input interrupts that are triggered by actual Hall sensor signals, tᵢₙ(n). The scheduled output software interrupts for modified switching signals are depicted on the top axis, tₒᵤₜ(n). Assuming a certain reference time t̅(n) and a given τ̅(n), the correction term is calculated using (4-1)(4-2) as

τ^{corr}(n)=tₒᵤₜ(n+1)−tᵢₙ(n)= t̅(n)+ τ̅(n)−tᵢₙ(n). (4-9)

Computation of (4-9) requires knowledge of the reference time. This time may be obtained by averaging switching times of the three phases as depicted in FIG. 8.

t̅(n)=⅓(t(n)+t′(n)+t″(n)) (4-10)

Here, t(n) is time of the last switching of input Hall signal, and t′(n) and t″(n) are the times extrapolated from the two preceding input Hall signal transition times, as follows:

t′(n)=tᵢₙ(n−1)+ τ̅(n)

t″(n)=tᵢₙ(n−2)+2 τ̅(n) (4-11)

As can be seen in FIG. 8, the most recent input interrupt has occurred at tᵢₙ(n). Last two input interrupts have occurred at tᵢₙ(n−1) and tᵢₙ(n−2) respectively. These times are used to calculate extrapolated terms according to (4-11), and then the reference time according to (4-10).

Combining the results, reference time is calculated in terms of input interrupts as:

t̅(n)=⅓(tᵢₙ(n)+tᵢₙ(n−1)+tᵢₙ(n−2))+ τ̅(n) (4-12)

Since tᵢₙ(n−1) and tᵢₙ(n−2) refer to the previous input interrupt times, they can be expressed as:

tᵢₙ(n−1)=tᵢₙ(n)−τ(n−1) (4-13)

tᵢₙ(n−2)=tᵢₙ(n)−τ(n−2)−τ(n−1) (4-14)

Combining (4-12)-(4-14) and (4-9), the correction term is represented as:

τ^{corr}(n)=⅓(−2τ(n−1)−τ(n−2))+2 τ̅(n) (4-15)

Correction term τ^{corr}(n) can now be used for whole range of different filters presented in [24], [19], and [20] by substituting the appropriate expression for τ̅(n). After all relevant substitutions and grouping of terms, the final correction terms for each filters (4-3)-(4-6) can be expressed as:

τₐ₃^{corr}(n)=⅓(τ(n−2)+2τ(n−3)) (4-16)

τₐ₆^{corr}(n)=⅓(−τ(n−1)+τ(n−3)+τ(n−4)+τ(n−5)+τ(n−6)) (4-17)

τₗ^{corr}(n)=⅓(2τ(n−1)+τ(n−2)+2τ(n−3)−2τ(n−4)) (4-18)

τ_{q}^{corr}(n)=⅓(4τ(n−1)−τ(n−2)+2τ(n−3)−4τ(n−4)+2τ(n−5)) (4-19)

Without loss of generality, here, we consider third order filter (4-16) to prove the SLC concept, but the proposed algorithm can readily be extended for higher order filters. Thus, the third order filter will be implemented using (4-3) and (4-16) which is computationally efficient and simple compared to [24].

### Digital Implementation of Hall-Sensor Signals Locking/Synchronizing

The SLC is based on constructing one set of Hall signals by appropriately modifying (filtering/averaging) the signals from actual sensors H_{M1}{1,2,3} and H_{M2}{1,2,3}. Averaging is done by first finding the rising edge offset term which is

τ_{dr}(n)=tᵣ^{b}(n)−tᵣ^{a}(n). (4-20)

Once the offset value τ_{dr}(n) is established, actual timing for commutating the inverter transistors for next cycle can be found as follows:

tᵣ^{out}(n+1)=tᵣ^{a}(n+1)+(½)τ_{dr}(n), (4-21)

where tᵣ^{a}(n), the leading motors switching time, is defined as reference switching time of the system. A similar approach is used for falling edges of the signals resulting in period of the average signal:

τ(n+1)=½((t_{f}^{a}(n)−tᵣ^{a}(n))+(t_{f}^{b}(n)−tᵣ^{b}(n))). (4-22)

Averaging algorithm is also based on the software ISR triggered by rising and falling edges of the input signals. As before, for each rising and falling edge, the ISR has a dedicated timer which is used to save the last two time periods between the edges as shown in FIG. 9. In this algorithm the latest time interval between interrupts is defined as τ₀, and the following one is defined as τ₁. The output interrupt is scheduled when τ₀>τ₁ to be triggered after τ₁/2 seconds. Same logic is used for averaging both rising and falling edges of the signals.

### Combined Implementation of Filtering and Locking of Hall-Sensor Signals

It is essential to integrate the mentioned filtering and locking techniques efficiently and minimize computational resources as much as possible. The filtering and locking techniques are integrated using only two software ISRs with dedicated timers. One ISR and timer is devoted to rising edges of the input signals, while another ISR and timer pair is used for falling edges of the input signals. Finally, the third timer is utilized for scheduling output interrupt for both the rising and falling edges.

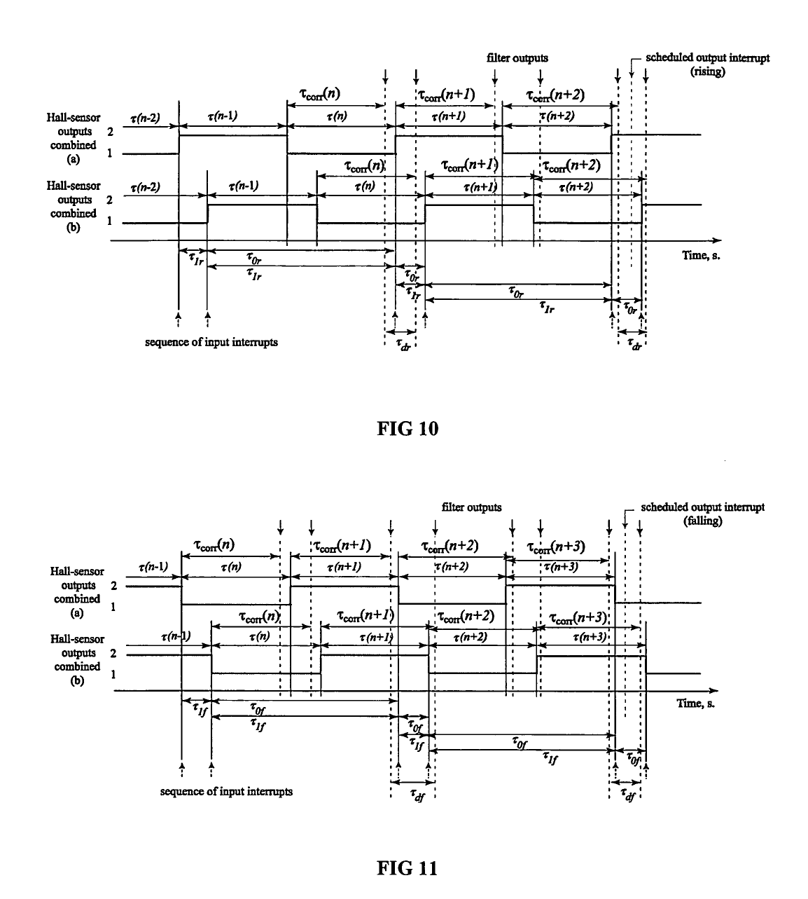

The algorithm can be explained by considering rising and falling edges of Hall signals separately. FIG. 10 illustrates timing of the rising edge interrupts. Output rising edge interrupt is scheduled at the input falling edge when τ_{0f}>τ_{1f} to be triggered at τ_{corr}(n+2)+τ_{dr}/2, where τ_{dr} is the offset between two signals defined at rising edge when τ₀ᵣ<τ₁ᵣ. This offset can be calculated as follows

τ_{dr}=τ₀ᵣ+(τ(n)−τ_{corr}(n))ₐ−(τ(n)−τ_{corr}(n))_{b}. (4-23)

Here, subscript “a” denotes period difference of the leading motor; and subscript “b” is used to denote period difference of the lagging motor. It should be noted that either one of motors 1 and 2 could be leading or lagging.

Similar to the rising edge interrupt, the output falling edge interrupt is scheduled at input rising edge when τ₀ᵣ>τ₁ᵣ to be triggered at τ_{corr}(n+3)+τ_{df}/2, where τ_{df} is the offset between two signals when τ_{0f}<τ_{1f} which can be calculated as

τ_{df}=τ_{0f}+(τ(n+1)−τ_{corr}(n+1))ₐ−(τ(n+1)−τ_{corr}(n+1))_{b}. (4-24)

As shown in FIG. 10 and FIG. 11, offset between two filtered signals is implemented by taking into account the fact that filtered signal could be located before or after the actual input interrupt. Relative position of the filtered and actual signal depends on many conditions, e.g. relative position errors, whether the motor is decelerating or accelerating, etc. Finally, in both the rising and falling edge interrupts when output ISR is invoked, next state of the Hall sensors is predicted according to the existing state and the direction of rotation. After that, output Hall signals will be changed to switch inverters of the motors into their next topological state. With this algorithm, closest two phases of two motors are averaged and locked together rather than the matching phases. This is desirable as the two motors may be locked together at any point during operation regardless of their relative positions.

### Hardware and Software Realization

In order to have a robust and reliable controller, we developed an algorithm that is able to handle special cases such as rapid acceleration/deceleration, overlap of Hall signals of two motors, overlap of filtered and actual Hall signals, lagging or leading filtered Hall signals, etc. This Section describes the developed controller algorithm and the hardware prototype that satisfies stated requirements.

### Software Flow Chart

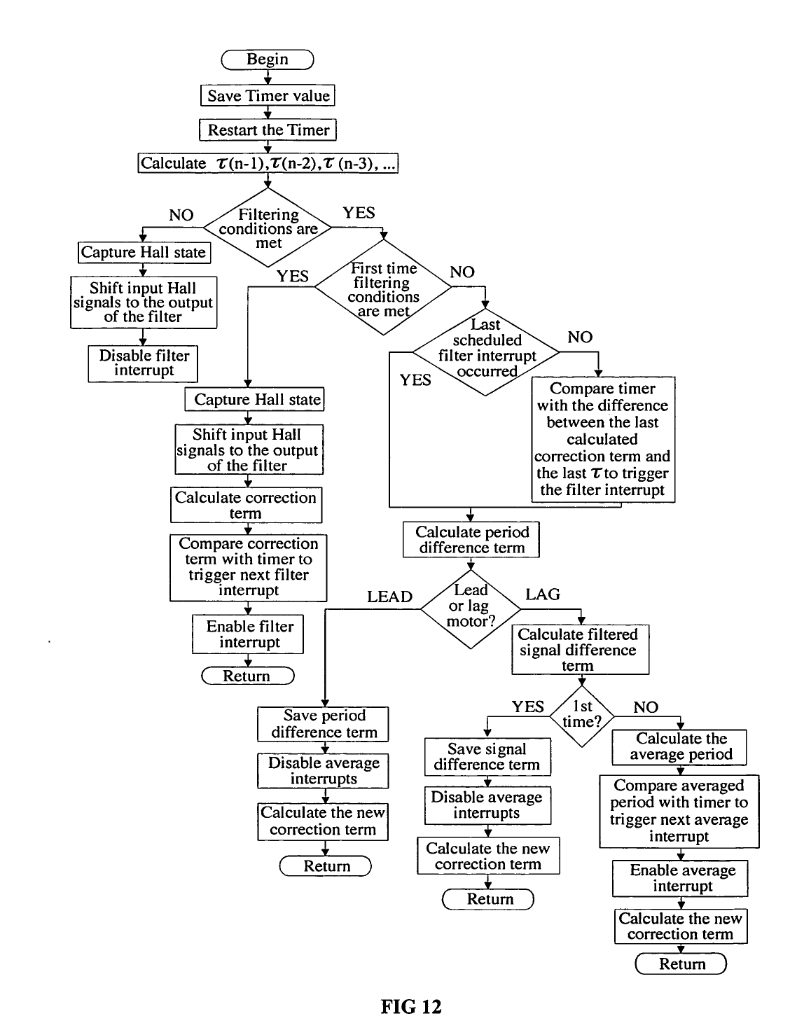

FIG. 12 illustrates a flow chart of the developed algorithm based on ISRs. Program starts by initializing the appropriate registers of the microcontroller. The controller calculations are triggered with first detection of the input software interrupt (i.e. change in state of a Hall signal). Upon this detection, the ISR will be invoked and the microcontroller will become ready to perform SLC operations. Due to inherent memory of the proposed filtering and averaging technique, the controller output signal will not be available right away. As the proposed averaging technique requires just one operational cycle, the delay is dominated by order of the filter used in the system. Depending on order of the filter, a certain number of input interrupts must be detected to record sufficient number of time intervals for proper operation of the filter. Considering that minimum order of the proposed filter is three, there is no need to check if the averaging condition has been met during operation as filtering requirement guarantees proper operation of signal averaging.

As mentioned previously, with one timer dedicated for rising edges and one for falling edges, the time interval between two edges of individual signals are recorded by reading the timer values at appropriate instances during the operation. After recording periods of the signals, filter conditions (i.e. not enough history terms, rapid acceleration/deceleration, deactivation of the filter by a manual switch, etc.) are verified as shown in FIG. 12. If filtering conditions are not met, existing Hall signals are passed directly to the output for switching inverter transistors. In this case, the controller is effectively disabled and no output interrupts are scheduled. If filtering conditions are met for the first time, Hall signals are still shifted through to the output but output filter interrupt is enabled this time. In addition, the correction term is calculated and used for scheduling the filter output interrupt. If filtering conditions are met and it is not the first time, then two different operations need to be handled. One of the operations is dedicated to filtering Hall signals and another one is devoted to averaging of Hall signals from the two motors.

For filtering Hall signals, output filter interrupts may have to be switched before or after the next input interrupt (rising/falling edges) depending on many conditions. In first scenario, output software interrupt is invoked earlier making inverter switching happen before the actual Hall-sensor-signal-transition. This could happen for example when motor is under deceleration and/or when a given Hall sensor has an error in direction of rotation. Then, at the time of input ISR corresponding correction term τ^{corr}(n) is calculated and used to schedule the next output software interrupt to make the inverter switch. In second scenario, actual Hall sensor signal comes ahead of what it should be in an ideal case. This may happen when the motor is accelerating and/or when a given Hall sensor has an error in opposite direction to the motor rotation. If this case, at the time of input ISR, when timer is reset to zero, next output software interrupt will be scheduled for the time determined by the difference τ^{corr}(n−1)−τ(n−1). In addition to this, another filter output interrupt for next switching interval should be scheduled as well. This is simply done by calculating new correction term τ^{corr}(n) and putting it as a second request for invoking the filter output interrupt.

For averaging Hall signals, in addition to period difference term, signal difference term (i.e. difference between the Hall signals of the two motors) is calculated. This term will only be available at the lagging signal interrupt. If it is the first time at lagging motor interrupt, the filtered Hall signals are just buffered through to the output but the output average interrupt is enabled. If it is not the first time at lagging motor interrupt, the average output interrupt is scheduled according to the signal difference term. Averaging of filtered Hall signals is also considered. Here, the two discussed scenarios (where the output filter interrupts may have to be switched before or after the next input interrupt) are taken care of inherently by defining the signal difference terms (4-23) and (4-24) with a positive leading motor period difference, (τ(n+1)−τ_{corr}(n+1))ₐ; and a negative lagging motor period difference, (τ(n+1)−τ_{corr}(n+1))_{b}.

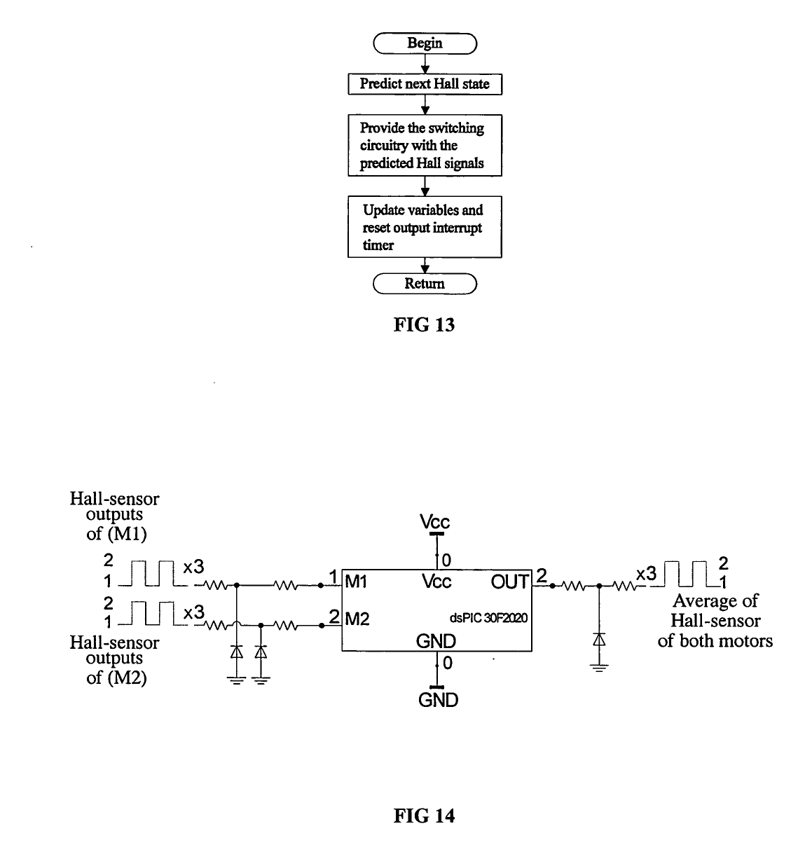

The steps performed during the output ISR are shown in FIG. 13. When the output ISR is invoked, next state of the Hall sensors is predicted according to existing state and direction of rotation of the two motors. Steps are the same for both filtering and averaging operations. It is just the matter of which state and at what point the inverter is switched. For filtering, the output Hall signals will be changed to switch the inverter into its next topological state. But for averaging, output Hall signal of the leading motor will be changed to switch the inverter into its current topological state while lagging motor will be changed to switch the inverter into its next topological state. After this point, all variables are updated and the output ISR is finished. The program then continues to run until next input interrupt is detected.

### Hardware Prototype

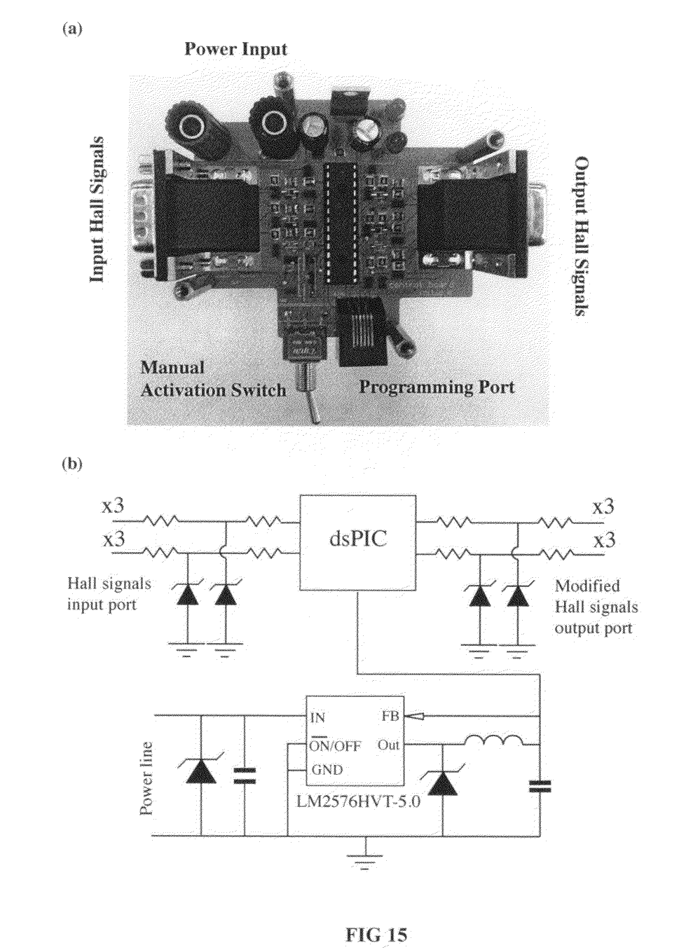

The Sync-Lock Controller has been realized on a basic programmable integrated circuit microcontroller (dsPIC30f2020) [40]. This and similar microcontrollers are often used in many inexpensive DC drive systems [41]. FIG. 14 shows a simplified diagram of the SLC unit. The controller accepts original Hall sensor signals as an input (input Hall signals), and provides switching circuitry with modified signals (output Hall signals).

Actual printed circuit board of the prototype and its simplified schematic are shown in FIGS. 15 (a) and (b), respectively. As shown in FIG. 15, the prototype SLC dongle has several auxiliary components in addition to the microcontroller in order to make it operational for various DC motor drive systems. The voltage regulator is designed to handle input voltages from 6 to 48 V_{dc}. In this arrangement, the dongle can be powered either from dc bus of the DC motor drivers or directly from dc supply that feeds Hall sensors of the motor. Input and output ports of the microcontroller are also protected against accidental over-voltage. The microcontroller can be re-programmed with different filters through its data programming port, as well as enabled or disabled using manual switch. Potentially, the dongle can be made much smaller if some of the auxiliary components are removed and/or optimized.

Hall sensors are simply connected with the DC driver through input and output ports provided on the board, thus enabling modification of Hall sensor signals according to the filtering and averaging methodologies. The filter equations (4-8) and (4-16) in conjunction with averaging equations (4-20)-(4-22) were programmed on the microcontroller according to the implementation approach summarized in previous section and the functional diagrams depicted in FIGS. 10 and 11.

### SUMMARY

An innovative approach is developed for synchronizing and locking multiple number of independently running DC motors. The new Sync-Lock Controller is based on filtering and averaging the Hall sensor signals and applying the same switching intervals to both motors. An analog and a digital implementation of the controller are developed and described in detail. As DC motors commonly have inaccurate Hall sensors, the hardware implementation also integrated filtering of the Hall sensor signals. Therefore by filtering and averaging the Hall sensor signals and applying the averaged switching intervals to both motors, we achieved desired locking/synchronizing.

The digital implementation of the controller is realized using a microcontroller. The controller is realized in the form of a standalone dongle-circuit that can be placed between the original Hall-sensors and the motor drive to process the signals. A compact prototype of the proposed dongle had been fabricated and texted on a number of typical industrial DC motors and drivers. Due to its simplicity and effective implementation, the developed algorithm can be readily applied to a variety of systems that use DC motors and drivers. The performance of the developed locking algorithm has been demonstrated using DC motors (with Hall-sensor positioning errors) and is shown to be efficient and robust in steady state and transients studies. The performance of developed SLC was evaluated under different conditions. It was shown that the SLC improves the performance of the system under certain conditions compared to the conventional PI speed control loops

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A device for locking or synchronizing motors electronically:
a) providing at least two Hall sensor driven motors,
b) providing said device is positioned such that the device has Hall sensor signals as its input and running said motor's drivers at its output,
c) configuring the device to receive said signals from Hall sensors and then synchronize or lock angle and speed of the motors,
d) configuring the device to operate the motors with common synchronized magnetic field with no one motor dictating the operation.

2. A method for mitigating Hall sensor signal errors in Hall sensor-based drive systems:
a) providing a programmable integrated circuit microcontroller positioned between said Hall sensors and said drive systems,
b) programming the programmable integrated circuit microcontroller to receive signals from the Hall sensors and filter out all undesirable errors in the signals.

3. A method for averaging non identical digital signals implemented in a motor-drive system, with two or more signals, said method comprising:
a) automatically detecting rapid acceleration and deceleration of said signals, overlap of the signals, and lagging and leading signals and establishing average signal accordingly,
b) automatically detecting phase shift between the signals, and correcting the difference between the signals before averaging the signals.
